(19) United States
(12) Patent Application Publication
(10) Pub. No.: US 2001/0010334 A1
(43) Pub. Date: Aug. 2, 2001

(54) System for processing mail items and method thereof

(76) Inventors: Moon Sung Park, Taejon (KR); Jae Gwan Song, Taejon (KR); Jae Gak Hwang, Taejon (KR); Yun Seok Nam, Taejon (KR); Dong Chin Woo, Taejon (KR); Hye Kyu Kim, Taejon (KR); Chee Hang Park, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/769,071

(22) Filed: Jan. 24, 2001

(30) Foreign Application Priority Data
Jan. 27, 2000 (KR) 2000-3860

(51) Int. Cl. G06K 7/10

(52) U.S. Cl. 235/462.14

(57) ABSTRACT

There is disclosed a method of exactly delivering a mail item and a method of processing the mail item depending on the delivery result. Conventionally, if mail information to be delivered to a recipient is erroneously written, the mail item is automatically sorted based on the erroneous information. Also, if the recipient is unknown, the mail item is manually sorted to return it to the sender. Thus, this conventional method has problems that it requires a lot of time in processing the mail item. In order to overcome these problems, the present invention allows a mail customer to write correct mail information into his/her mail item upon printing of a customer barcode, notifies information on the delivery process to the mail customer, effectively returns a return mail item and notifies information on the processing state to the mail customer. Also, the present invention allows a mail item that will not be delivered to be returned at its early state, so that the time of processing the mail item can be shorten and an effective mail item processing information can be obtained. As such, the present invention provides a method by which a mail item could be delivered based on exact mail information and a return mail item is effectively processed. Thus, the present invention can improve productivity of processing a mail work and provide a high quality of service to a mail customer.

### TECHNICAL FIELD

The invention relates generally to a system for receiving and processing mail items and method thereof. More particularly, the present invention relates to a system for processing mail items in which delivery can be exactly made using main information in the process of mail automatic sorting, and method thereof. The present invention automatically notifies the process in which mail item is received and is then processed to customers. If information on a recipient is wrong, the present invention corrects the wrong information to delivery correct information to the customer.

### BACKGROUND OF THE INVENTION

Generally, in case of a large-quantity mail items to be sent to a plurality of recipients by one sender, the mail items are printed with customer's barcode. Information contained in the customer's barcode printed on the mail items contains information for automatically sorting the mail items. The barcode printed on the mail items are used as an option for reading and automatically sorting the barcode and then delivering the result. Further, in order to analyze performance on receipt and processing procedure of the mail item, a mail item for test is generated and a procedure of the mail item from receipt to delivery is tested. As such, there is conventionally a problem that a mail item for test and a mail item for general purpose must be processed by sort.

Also, a mail address verification system periodically verifies whether mail information on a mail user is correct or not, using mail address database. In case of a conventional registered mail item, in order for a mail user to confirm whether the mail has delivered or not, he/she must confirm it with papers related the post office and can confirm the state of delivery after a given period of time. In particular, in case of mail items to be sent with large-quantity, it is impossible to confirm the state of its delivery and to know when his/her mail item can be arrived in view of its recipient.

Further, if a mail item is not delivered due to change of the recipient' address, it must be manually sorted in order to forward it to its sender. As such, even after the recipient's address is changed, the mail item is experienced by plural steps of mail automatic sorting processes so that it can be delivered to the recipient's address written in the mail item. Next, a mail carrier notices that the recipient's address is wrong and then returns it to the sender. In other words, mail items, which can be returned but could not be delivered to the recipient due to wrong address, are experienced by the same automatic sorting process and delivery process to the normal mail item. Due to these processes, a lot of time is taken to process the mail item and a lot of efforts are made to process a returned mail item.

In order to deliver a mail item to a correct recipient's address, a postal service server in the postal office must store an automatic sorting code (zip code, delivery sequence code) and also print parity bits when a customer's barcode code is printed on a mail item. By doing so, if a customer inputs the zip code and the recipient's address only, the customer's barcode necessary for the mail service server can be automatically printed. Further, the results of processing the mail item must be informed to the recipient as well as the sender. Also, completion of delivery must be informed to the sender by information inputted by the mail carrier upon completion of delivery.

In summary, though a large-quantity mail items (more than 3 billions per year in the domestic mail item, about 65% of them are requested by a large-quantity mail customers), which occupy a major part among the mail items, have customer's barcodes attached thereon, only an automatic sorting process using a wrong zip code, a wrong delivery sequence code, etc. on customer's barcode written on the mail items. Thus, there is a need for a method by which delivery of a mail item can be effectively processed. Also, in a prior art, as one option to improve the quality of postal service, a sample mail item is periodically sent and the time to process it is measured in order to monitor the processional flow of a mail item. This method, however, requires additional efforts accordingly. Also, when a mail item is processed by means of a conventional method, there are problem that not only the delivery state could not be confirmed but also a lot of time and efforts are necessary. In addition, there is a problem that a mail item to be returned could not be known before it is delivered to the recipient's address.

### SUMMARY OF THE INVENTION

The present invention is contrived to solve the above problems and has its purpose to provide a method by which information supplied by a postal service server in the postal office can be written on a customer's barcode so it can be accepted by a mail user, a delivery sorting process is performed after the accepted mail item is checked about whether it is correct or not through automatic sorting process, and information on the processed date and time, etc. is confirmed.

Also, in the present invention, process information is transmitted to a mail customer who requested a delivery confirmation notification service for the postal service server. Thus, it can provide an additional service and information on the process time from reception of a mail item to its delivery the mail customer. According to the present invention, even in case of a mail item to be returned, automatic sorting process information corresponding to a customer's ID printed on a customer's barcode is searched and is automatically sorted, so that it can be returned. Also, if a mail item must be returned, information on the return state is sent to the sender at the same time when the mail item is experienced by automatic sorting process. Thus, re-forwarding of a mail item to a wrong address and recipient could be prevented. In addition, a zip code and a recipient name of the returned mail item is stored and is then informed to the mail user. Thus, only a mail item bearing correct zip code and recipient name could be sent.

In order to accomplish the above object, a system for automatically processing a mail item according to the present invention is characterized in that it comprises mail item automatic sorting process information generating/printing means for printing the automatic sorting process information including a zip code, a delivery sequence code and a mail item ID on the mail item with a barcode, using information on the zip code and the name of a recipient inputted by a sender of the mail item; mail item processing means for reading the barcode and for performing automatic sorting process to deliver the mail item to the recipient, if the mail item on which the barcode is printed is received; and return mail item processing means for reading the barcode of a return mail item to return the mail item to the sender and for transferring information on the mail item process state to the sender, if the mail item is returned to the recipient.

Also, a method of automatically processing a mail item according to the present invention is characterized in that it comprises a mail item generating step of printing automatic sorting process information including a zip code, a delivery sequence code, a mail item ID, etc. with a customer's barcode, using information on the zip code and the name of a recipient inputted by a sender of the mail item; a mail item processing step of reading the customer's barcode and of performing automatic sorting process to deliver the mail item to the recipient, if the mail item on which the barcode is printed is received at a postal centralization office; and a return mail item processing step of reading the customer's barcode of a return mail item to return the mail item to the sender and of transferring information on the mail item process state to the sender, if the mail item is returned to the recipient.

The present invention automatically notifies information during the processing of a mail item to a mail customer using the name of a recipient and a customer ID of a sender printed on a customer barcode that is previously printed by the mail customer in the procedure of receiving/processing a mail item. Also, if information on the recipient of the received mail item is erroneous, the present invention delivers the mail item based on correct information by correcting the erroneous information.

Further, the present invention automatically generates a zip code and a delivery sequence code necessary to print a customer barcode using a zip code and information on the recipient's name, which are written by a mail customer. Also, the present invention notifies the state in which the mail item is being processed on the E-mail address of a sender, so that the sender can know the processing procedure of the mail item. If the mail item is returned due to erroneous recipient's information, the present invention reads the customer barcode information to generate mail information (zip code and delivery sequence code) of the sender and to print and automatically sort a return barcode, so that the mail item could be rapidly returned. Further, the present invention provides information by which the mail item is prevented from being forwarded again, by previously notifying the return information to the sender. Also, in case of a normal mail item, when a to-be returned mail item and a mail item to be forwarded to the recipient are occurred, it is compared with a return information list to inform at an early stage that the forwarding is impossible and the mail item is simultaneously returned to the sender, so that the time for processing the return-impossible mail item could be shorten.

### BRIEF DESCRIPTION OF THE DRAWINGS

The aforementioned aspects and other features of the present invention will be explained in the following description, taken in conjunction with the accompanying drawings, wherein:

FIG. 1 shows a construction illustrating a system for confirming delivery of mail items and for notifying the results according to one embodiment of the present invention;

FIG. 2 is a flowchart for illustrating a method of generating mail forwarding information in a system for confirming delivery of mail items and for notifying the results according to one embodiment of the present invention;

FIG. 3 is a flowchart for illustrating a method of confirming/notifying delivery in a system for confirming delivery of mail items and for notifying the results according to one embodiment of the present invention;

FIG. 4 is a flowchart for illustrating a method of processing normal mail items on which customer's barcodes are not printed in a system for confirming delivery of mail items and for notifying the results according to one embodiment of the present invention; and

FIG. 5 is a flowchart for illustrating a method of processing to-be returned mail items on which customer's barcodes are not printed in a system for confirming delivery of mail items and for notifying the results according to one embodiment of the present invention.

### DETAILED DESCRIPTION OF THE INVENTION

“System for processing mail items and method thereof” according to one embodiment of the present invention will be now explained by reference to accompanying drawings.

An apparatus for processing mail items according to one embodiment of the present invention will be below explained in short. When a large-quantity mail user prints a customer's barcode on a mail item, the large-quantity mail user first registers his/her zip code and E-mail address, etc. into a postal service server in the postal office and then inputs a zip code and name of the recipient. Then, the postal service server receives them to generate information frame to be printed on 4-state barcode and a code word for error correction and then transmits the formation frame and the code word to a barcode printing system to print a customer's barcode. Also, the mail item on which the customer's barcode is printed is transmitted to a first mail centralization office where the mail item is experienced by a mail item automatic sorting. The first mail centralization office reads a customer's ID (that is, sender's name) and a mail ID, and information on a recipient out of the customer's barcode and then searches information on the recipient from a to-be returned mail list. Then, the mail centralization directly informs a large-quantity mail user, who sent the mail item, of the result or allows the sender to search the customer ID, the mail ID and the recipient name through the postal service server. In particular, in case that information on the recipient is sorted as a to-be returned mail item, in order to return it to the sender, it performs a return process by converting an automatic sorting process system mode into a to-be returned process mode by a given amount of mail item unit or a work time unit, automatically sorting the to-be returned mail item and transferring it to the delivery office. If information on the recipient does not exist in the to-be returned mail item list, it automatically sorts it by rear 3-digits in the zip code. As such, if the mail is not the to-be returned mail item, in order to deliver the mail item, the first mail centralization office forwards it to a second mail centralization office.

The second mail centralization office performs an automatic sorting process for the mail item by rear 3-digits in the zip code and then informs the result of reading the barcode to the large-quantity mail user who sent the mail item in the same manner to the process in the first mail centralization office or allows the sender to search and confirm the mail item through the mail service server. The mail item that was normally processed so far is transmitted to the delivery office, where automatically sorts the mail item using the regular route (automatic sorter by means of delivery sequence code). Then, a mail carrier delivers the mail item to the recipient. In case that the mail item is returned due to absence of the recipient (i.e., change of address), the mail automatic sorting process system reads a customer ID in the customer barcode information and uses the customer ID to search a customer database. Then, the system prints a zip code of a sender searched using the customer ID and a delivery sequence code with a return barcode and then uses the return barcode to automatically sort the return mail item. Also, the to-be returned mail item process uses an E-mail address searched from the customer ID among information on the return mail item to transmit an ID of the return mail item, a recipient name, a starting date to be returned and time information to the mail service server. Further, it forwards a message for allowing the large-quantity mail user to change and confirm the address of the mail item.

The present invention not only performs a mail automatic sorting process effectively but also allows a mail customer to obtain a customer barcode printing information using mail address information. The mail centralization office (mail process center) accepts the mail item on which a customer barcode is printed, and the barcode reader and sorter sort the mail item. At this time, it is confirmed whether the mail item is a to-be returned mail item by means of a zip code, a delivery sequence code and a recipient name which are read from the barcode or not. Thus, only a normal mail item is automatically sorted. On the other hand, in case of a normal mail item (a mail item on which a barcode is not printed), transmitted from the mail collecting office to the mail centralization office, an optical character recognition (OCR) machine reads a mail address information out of the mail item and then prints a zip code and a delivery sequence code with a barcode. The mail item may be automatically sorted/delivered by a barcode reader and sorter. A zip code and a delivery sequence code are generated by means of address information recognized in the process of reading optical characters, and it is confirmed whether the mail item is a to-be returned mail item by means of the recognized recipient's name. Then, on the mail item is printed a barcode and is then automatically sorted. Also, the automatic sorting process result for the customer barcode printing mail item is stored/managed so that it can be serviced to a mail customer. In case that the mail item must be returned due to change of the recipient's address during this process, a customer barcode is read to obtain a zip code and a delivery sequence code using a customer ID of a sender, so that the mail item is automatically sorted.

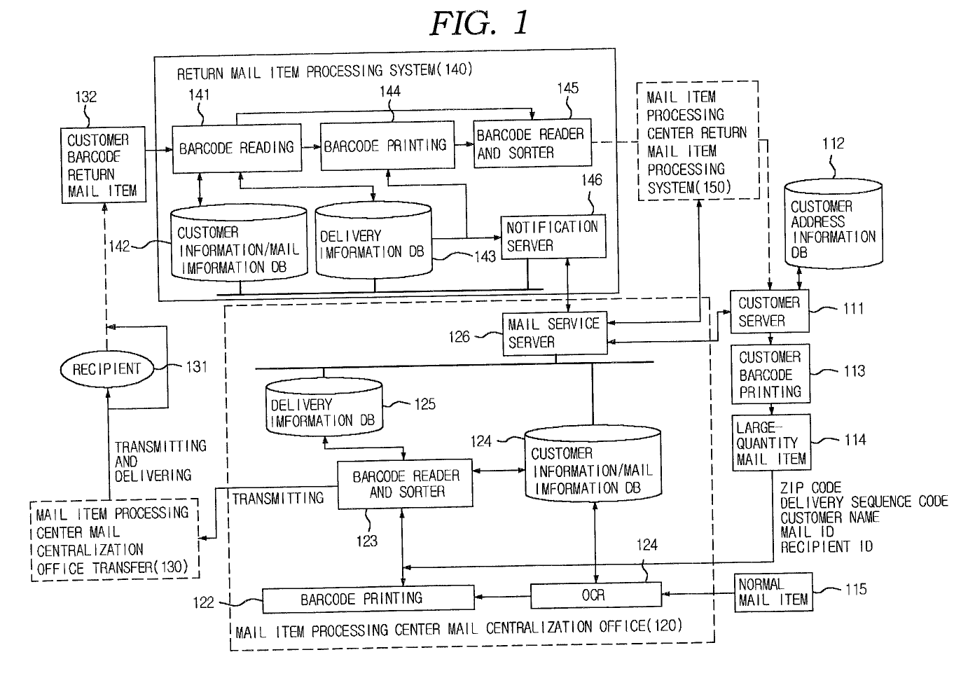

FIG. 1 shows a construction illustrating a mail item processing system according to one embodiment of the present invention.

A mail customer inputs forwarding information using a customer server 111 in order to forward a mail item or reads the quantity of a mail and mail address information from a customer address information database 112 to change/add/conform the address information. If forwarding of the mail item is requested, the customer server 111 forwards it to a mail service server 126 in a first mail centralization office being a mail item process center. The mail service server 126 searches a delivery information database 125 in order to confirm registration information of a customer (customer ID, E-mail address, etc.). Then, it confirms that he/she is a registered customer. If the mail service server 126 accepts connection thereto, a customer server 111 for a large-quantity mail user transmits a mail address and information on a recipient for generating a mail item to the mail service server 126 in the postal center. Next, the mail service server 126 generates a mail address and a delivery sequence code depending on the received mail address using the delivery information database 125. Then, the mail server 126 generates a code word for error correction, which is required upon printing of a customer barcode, to transmit the code word to the customer server 111.

At this time, the customer server 111 prints the barcode printing information received from the mail service server 126 on a mail envelope or a label, with a barcode, wherein a customer barcode is printed 113 in an order of a zip code of a recipient, a delivery sequence code, a customer ID, a generated ID of a mail item, the name of the recipient, a code word for error correction, etc., so that a large-quantity mail item 114 is generated.

If the large-quantity mail item 114 on which the customer barcode is printed is transferred to the first mail centralization office 120, a barcode reader and sorter 123 reads the customer barcode and then searches the customer information/mail information database 124 using the result of reading the zip code, the delivery sequence code and the name of the recipient among the barcode information, thus confirming whether a corresponding recipient is contained in the to-be returned list. At this time, if the mail item must be returned, the barcode reader and sorter 123 sorts it into a separate box so that it can be immediately returned. If not, the barcode reader and sorter 123 automatically sorts the mail item by means of the zip code or the delivery sequence code. Also, information on the processed result is stored at the delivery information database 125, in which a corresponding customer ID, a processing time, a processing result, etc. are stored. The mail service server 126 may directly transmit information on the processed result to the Email address in the customer server 111 for the large-quantity mail user.

The mail item, which is firstly sorted in the first mail centralization office 120 through these processes, is experienced by the same method to the process performed by the first mail centralization office 120, in a third mail centralization office 130. The result by which the mail item is automatically sorted/processed is stored at the delivery information database in the second or third mail centralization office and the mail service server in each of the mail centralization offices may directly transmit the processed result to the E-mail address in the customer server 111 for the large-quantity mail user.

In the process by which the mail item is transmitted and delivered to the recipient 131, a mail item 132 that must be returned due to lack of the recipient is processed by the following procedure. If a delivery man inputs the to-be returned mail item into the return mail item processing system 140 in the delivery center, the barcode reader 141 reads a customer barcode of the return mail item to obtain a zip code and a delivery sequence code corresponding to a customer ID. The zip code and the delivery sequence code corresponding to the customer ID may be obtained by searching the customer information/mail information database 142. Thus obtained zip code and the delivery sequence code are printed 144 on the mail item with a barcode or allow the mail item to be automatically sorted. Also, in order to inform that the mail item is not delivered to the sender, the processed information such as the name of a delivery office, date, time, a recipient's zip code, a delivery sequence code, a recipient's name, a customer ID, etc. is stored at the delivery information database 143. After the return information is thus stored at the delivery information database 143, a notification server 146 transmits information on the return mail item to the mail service server 126 in each of the mail centralization offices. At the same time, the mail service server 126 and the notification server 146 adds or changes information on the return mail item in the customer information/mail information database 124 by a given time period. The mail service server 126 searches E-mail address of the mail customer to transmit information on the return state of the mail item or allows a mail customer to search information on a return state of the mail item through the mail service server 126 via the customer server 111.

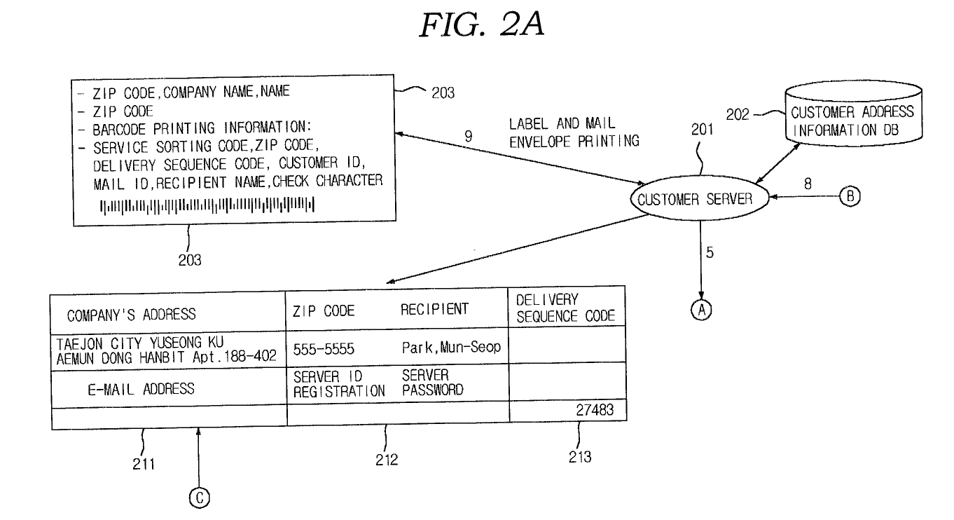

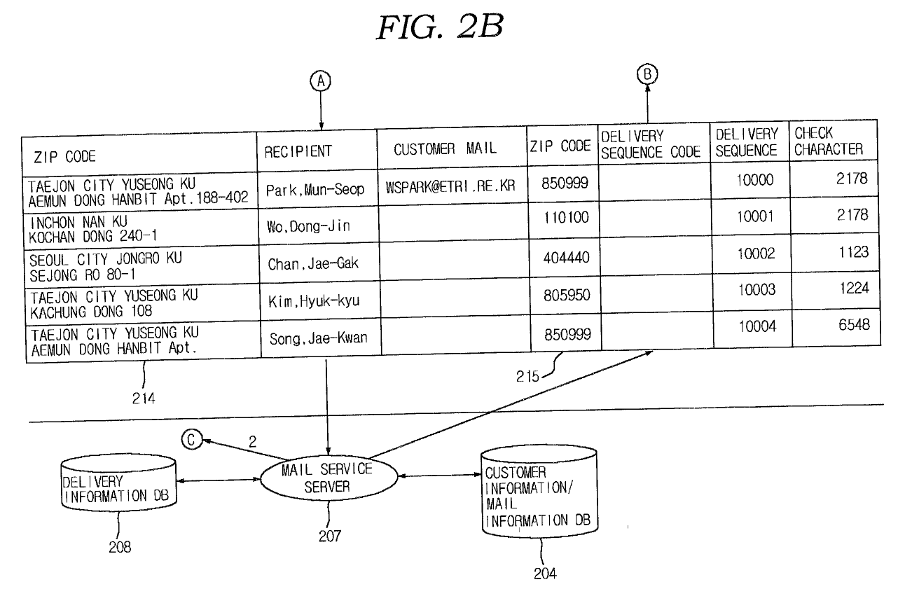

FIG. 2 is a flowchart for explaining a process of generating mail item forwarding information. If a zip code, E-mail address, a request for a mail service server ID, mail service server passwords 211, 212, etc. are inputted to the mail service server 207 in the postal office by the mail customer who wants to register as a mail customer using his/her customer server 201, the mail service server 207 compares them with information on the customers registered in the delivery information database 208 to give a server ID to a new mail customer. After this process is completed, the mail service server 207 gives a unique customer ID 213 to the mail customer who wanted registration and then registers it into the delivery information database 211, 212 and 213. This allows registration by means of a method of transmitting information registered at the customer server 201 of the mail customer.

If the mail customer wants to forward the mail item, he/she accesses the customer address information database 202 via the customer server 201 to obtain forward address information (zip code, recipient, recipient's E-mail address) 214. If this information is transmitted to the mail service server 207 using file transfer protocol (FTP) scheme, the mail service server 207 uses the zip code to generate a zip code, a delivery sequence code and a sequence of the mail item 215, and a check character 215 (error correction code word) used for error correction and then transmits them to the customer server 201. At this time, the error correction code word may be directly generated in the customer server 201 not in the mail service server 207. If the customer server 201 receives this information from the mail service server 207, it prints a customer barcode 213 consisted in the order of a mail order, a recipient's name and a check character, which are the zip code, the delivery sequence code and the sequence information of the mail item, on the mail item to be sent, so that the mail item can be accepted at the mail centralization office.

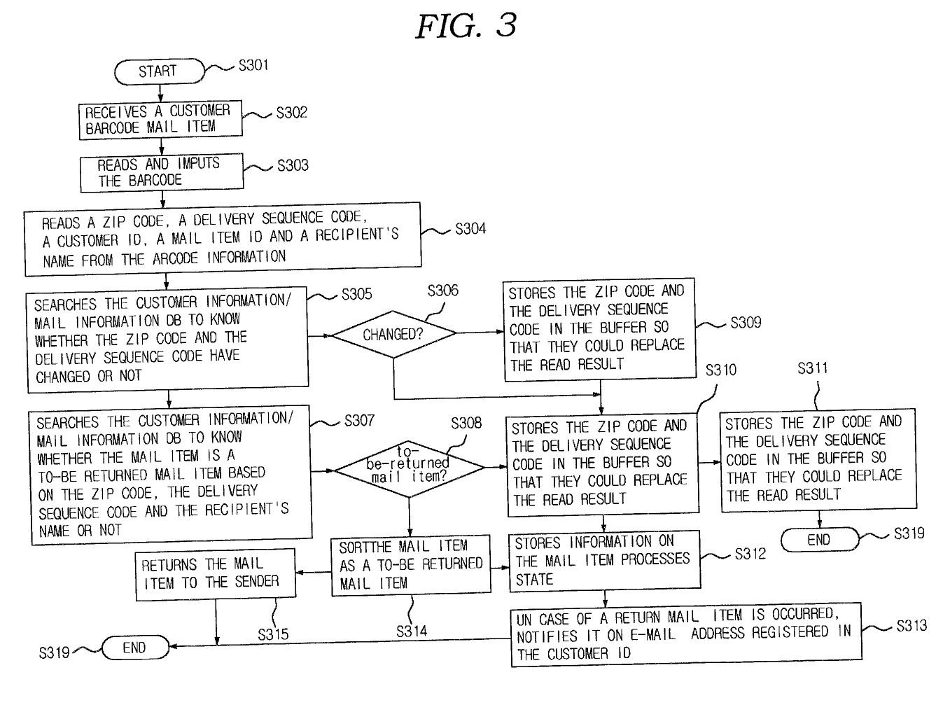

FIG. 3 is a flowchart for explaining a method of processing a mail item on which a customer barcode is printed and of notifying delivery confirmation information in a method of processing the mail item, according to the present invention. If a mail item on which a customer barcode is printed is accepted S301 and S302, the accepted mail item is inputted into the barcode reader and sorter. Then, the barcode reader and sorter reads a customer barcode from a barcode reading function and then acquires a zip code, a delivery sequence code and the name of the recipient from the read information S304. Next, in order to confirm whether the zip code and the delivery sequence code are changed or not from the obtained information, the customer information/mail information database is searched S305. If they are not changed S306, the result of the reading is maintained. If they are changed S306, however, the zip code and the delivery sequence code are stored at a temporary buffer S309, in order to change the read information in the order of the changed zip code and the delivery sequence code.

Meanwhile, after the step S305, the customer information/mail information database are searched by the zip code, the delivery sequence code and the name of the recipient to confirm whether the recipient's information is contained in the to-be returned mail item S307. If the mail item is not the to-be-returned mail item S308, the mail item is automatically sorted using the zip code and the delivery sequence code S310, so that it can be delivered to the recipient S311. Then, the process is finished S319. If it is the to-be returned mail item S308, however, the mail item is sorted into a to-be returned mail item box, so that the mail item can be returned to the sender S315.

Information (process date, time, customer ID, mail sequence, ID at the processed location, information on a return state) on the mail item processed thus S310 and S314 is stored at the delivery information database S312. If necessary, the information may be notified by the mail service server to the recipient or the sender (mail customer) using E-mail. Then, the information is made so that the mail customer can search it and the process is thus finished S319.

The zip code and the delivery sequence code existing at the customer information/mail information database are periodically changed by an internal decision making method so that a mail item automatic process can be effectively performed in case that the zip code and the delivery sequence code are changed.

The zip code change information may be collected by means of address change report of a deliver man or a mail customer.

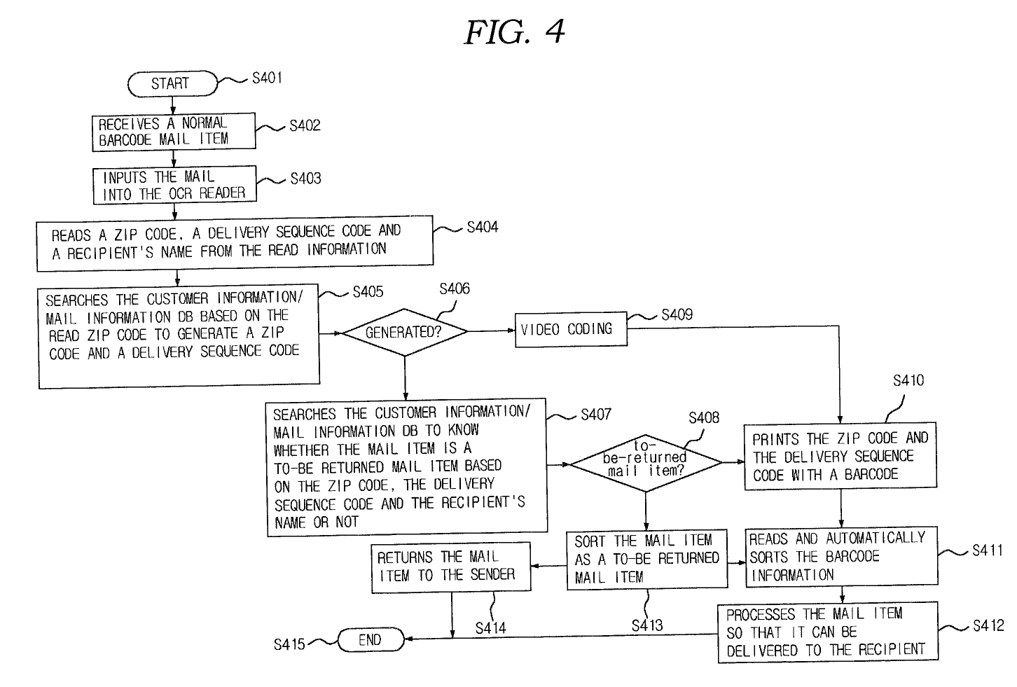

FIG. 4 is a flowchart for illustrating a method of processing normal mail items in a method of processing a mail item according to the present invention.

If a normal mail item on which a customer barcode is not printed is received S401 and S402, the received normal mail item is inputted into the OCR reader S403. At this time, zip code information and a recipient's name are recognized from a Hangul recognition function S404 and a zip code and a delivery sequence code are generated based on the read-out information S405. In case that the zip code and the delivery sequence code are not generated S406, a barcode is printed through a video coding process S409 by means of a conventional method and the mail item is automatically sorted based on it S411. Then, the mail item is processed so that it can be delivered to the recipient S412 and then the process is finished S413. During the video coding process, information on a zip code, a delivery sequence code and a recipient's name may be inputted. At this time, a method by which a to-be returned mail item is sorted as a to-be returned mail item upon reading of the barcode, by searching the customer information/mail information database, may be applied.

If the mail item is normally recognized/generated by the OCR reader S406, whether or not the mail item exists in the to-be returned mail item information by the zip code, the delivery sequence code and the recipient's name using information such as the zip code, the delivery sequence code and the recipient's name is searched. As a result of the search, if it is not the to-be returned mail item S408, a zip code, a delivery sequence code and a check character for barcode error correction are generated, so that a barcode is printed S410. Then, the barcode is read to perform automatic sorting process S411. If it is the to-be returned mail item S408, the mail item is sorted into a to-be returned box S413 and is returned to the sender S414, and the process is finished S415.

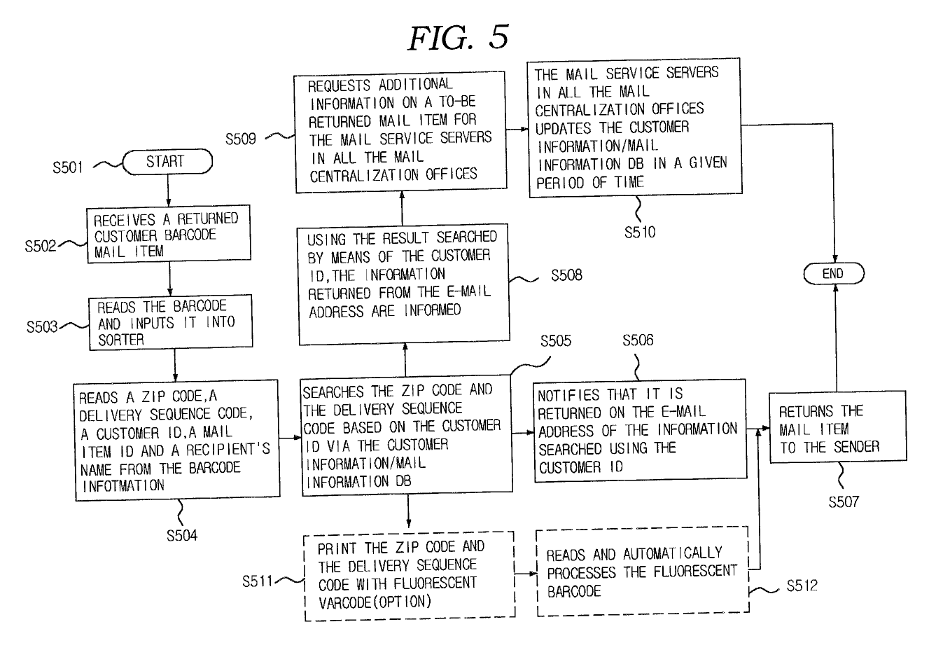

FIG. 5 is a flowchart for explaining a method of processing to-be returned mail items in a method of processing a mil item according to the present invention.

In case that a mail item could not be delivered due to lack of the recipient and change of the address, the return process flow is began S501. If a mail item on which a customer barcode is printed among the to-be-returned mail items is received S502, the received to-be returned mail item is inputted into the OCR reader in the to-be returned mail item processing system S503, which reads all the information contained in the customer barcode S504. Then, a customer ID among the read-out information is used to search the customer information/mail information database, thus obtaining a zip code, a delivery sequence code, E-mail address, etc. of the sender. After the zip code of the sender and the delivery sequence code are obtained, this information is printed with barcode S511. By reading the barcode, automatic sorting process is performed S512. In the above, the steps S511 and S512 may be selectively performed or not performed. Using the zip code and the delivery sequence code searched in the step S505, automatic sorting process is performed S506 and a return process is performed S507. Then, using the result searched by means of the customer ID, the ID of the mail item returned to the E-mail address of the sender, the date when the return process is performed, time, the ID of the processing subject, etc. are generated and informed S508. The returned zip code information is temporarily stored at the delivery information database, and information on the mail item is transmitted so that it can be stored/managed at the delivery information database via the mail service server in all the mail centralization offices by a given time unit.

The present invention has been described with reference to a particular embodiment in connection with a particular application Those having ordinary skill in the art and access to the teachings of the present invention will recognize additional modifications and applications within the scope thereof.

It is therefore intended by the appended claims to cover any and all such applications, modifications, and embodiments within the scope of the present invention.

As mentioned above, according to the present invention, mail information capable of delivering a mail item on which a customer barcode is printed more precisely is provided. Also, a to-be returned mail item can be sorted and returned at its early stage. Further, forwarding information of a sender can be automatically processed even in the process of returning a mail item. Thus, the present invention can minimize efforts to process a to-be returned mail item. Also, it can improve productivity in processing a mail item since a to-be returned mail item can be quickly processed.

In addition, the present invention has outstanding effects that statistic information, etc. on the mail item process could be easily obtained, process time information contained at the delivery information database can be utilized by a method of acquiring information on the mail item service quality and the quality of a zip code for performing a mail item return process could be improved. Further, it can provide a better mail service since a returned mail item is not returned again by providing it to the mail customer.

What is claimed is:

1. A system for automatically processing a mail item, comprising:
mail item automatic sorting process information generating/printing means for printing said automatic sorting process information including a zip code, a delivery sequence code and a mail item ID on the mail item with a barcode, using information on the zip code and the name of a recipient inputted by a sender of the mail item;
mail item processing means for reading said barcode and for performing automatic sorting process to deliver said mail item to the recipient, if the mail item on which the barcode is printed is received; and
return mail item processing means for reading the barcode of a return mail item to return the mail item to the sender and for transferring information on the mail item process state to the sender, if the mail item is returned to the recipient.

2. The system according to claim 1, wherein if a mail item on which a barcode is printed is received, the mail item processing means determines whether or not the recipient's information is contained in to-be returned mail item information by reading the barcode printed on the mail item, and returns the mail item if the recipient's information is contained at the to-be returned mail item information.

3. The system according to claim 2, wherein the recipient's information that is returned by the return mail item processing means is contained in the to-be returned mail item information.

4. A method of automatically processing a mail item, comprising:
a mail item generating step of printing automatic sorting process information including a zip code, a delivery sequence code, a mail item ID, a customer ID and a recipient's name with a customer's barcode, using information on the zip code and the name of a recipient inputted by a sender of the mail item;
a mail item processing step of reading said customer's barcode and of performing automatic sorting process to deliver said mail item to the recipient, if the mail item on which the barcode is printed is received at a postal centralization office; and
a return mail item processing step of reading the customer's barcode of a return mail item to return the mail item to the sender and of transferring information on the mail item process state to the sender, if the mail item is returned to the recipient.

5. The method according to claim 4, wherein said mail item processing step further includes:
a barcode reading and processing sub-step of reading and automatically sorting the barcode, if a mail item on which the barcode is printed;
a mail item process sub-step of returning the mail item to the sender if the recipient's information is contained in the to-be returned information as a result of reading said barcode and of forwarding the mail item to the recipient if information on the recipient is not the to-be returned information; and
a mail item processing state transferring sub-step of transmitting the state information in said mail item process sub-step to the sender.

6. The method according to claim 4, if a normal mail item on which a barcode is not printed is received, the recipient's a zip code of the normal mail item and the recipient's name is recognized, a zip code and a delivery sequence code are generated by means of said zip code, if the recognized recipient's name, the generated zip code and the delivery sequence code information are contained at the to-be returned information, they are returned to the sender, if the normal mail item is not the to-be returned mail item, the zip code and the delivery sequence code are printed with barcode so that the mail item can be transmitted to the recipient, and the mail item is automatically sorted by reading the barcode.

7. The method according to claim 4, wherein said return mail item processing step further includes sub-steps of:
reading a barcode on which a mail item is printed to read a sender's information, if a to-be returned mail item is printed;
automatically sorting the to-be returned mail item by the zip code of the sender and the delivery sequence code, to return the mail item to the sender; and
transmitting the state information on the return process of the mail item to the sender.

8. The method according to claim 7, further includes:
a step of printing the zip code of the sender and the delivery sequence code on the to-be returned mail item with a barcode; and
a step of reading and automatically sorting the barcode printed on the to-be returned mail item to return the mail item to the sender.

9. The method according to claim 7, wherein the recipient's information of the to-be returned mail item is contained in the to-be returned mail item.
